(19) United States
(12) Patent Application Publication
(10) Pub. No.: US 2019/0394687 A1
(43) Pub. Date: Dec. 26, 2019

(54) Integrated Access and Backhaul Next Generation NodeB Capabilities and Signaling

(71) Applicant: Sharp Laboratories of America, Inc., Vancouver, WA (US)

(72) Inventors: John M. Kowalski, Vancouver, WA (US); Tatsushi Aiba, Vancouver, WA (US); Kazunari Yokomakura, Vancouver, WA (US); Kenneth James Park, Cathlamet, WA (US)

(21) Appl. No.: 16/447,953

(22) Filed: Jun. 20, 2019

Related U.S. Application Data
(63) Continuation of application No. PCT/US2019/038349, filed on Jun. 20, 2019.
(60) Provisional application No. 62/689,044, filed on Jun. 22, 2018.

(51) Int. Cl. H04W 36/00

(52) U.S. Cl. CPC H04W 36/0061; H04W 84/042

(57) ABSTRACT

Systems, methods, and devices for an Integrated Access and Backhaul (IAB) node comprising: processing circuitry configured to communicate IAB information with an another IAB node; and transmitting circuitry configured to transmit, to the another IAB node, a set of one or more parameters used for coordinating downlink resources and uplink resources in radio resources to be used for the IAB communication. Other embodiments include an Integrated Access and Backhaul (IAB) node comprising: processing circuitry configured to communicate IAB information with an another IAB node; and receiving circuitry configured to receive, from the another IAB node, a set of one or more parameters used for coordinating downlink resources and uplink resources in radio resources to be used for the IAB communication.

### CROSS-REFERENCE TO RELATED APPLICATIONS

This application is a continuation of International Patent Application No. PCT/US19/38349, filed Jun. 20, 2019, which claims priority to and benefit of U.S. Provisional Patent Application Ser. No. 62/689,044 filed Jun. 22, 2018, all of which are incorporated herein by reference in their entirety for all purposes.

### FIELD OF ENDEAVOR

The present embodiments relate to Integrated Access and Backhaul and backhauling for New Radio (NR) networks having Next generation NodeB capabilities and signaling. In particular, the present embodiments relate to a wireless backhaul infrastructure which meets stringent performance, reliability, and operational efficiency targets via exchanging capabilities needed to control the NR features that exist in NR between different nodes.

### BACKGROUND

In Long-Term Evolution (LTE) and New Radio (NR), User Equipment (UE) capability information is sent from the UE to a base station. Examples of base station may be E-UTRAN Node B or Evolved Node B (eNB) or NR, at least the NG-RAN NodeB or Next generation NodeB (gNB) for LTE and NR respectively. The capability information is sent so that the network may best use the capabilities of the UE for optimum use of time/frequency/space resources.

### SUMMARY

The various embodiments of the present Integrated Access and Backhaul Next generation NodeB Capabilities and Signaling have several features, no single one of which is solely responsible for their desirable attributes. Without limiting the scope of the present embodiments as expressed by the claims that follow, their more prominent features now will be discussed briefly. After considering this discussion, and particularly after reading the section entitled “Detailed Description,” one will understand how the features of the present embodiments provide the advantages described herein.

In one device embodiment, an Integrated Access and Backhaul (IAB) node is disclosed as comprising: processing circuitry configured to have a capability to communicate IAB information with an another IAB node; and transmitting circuitry configured to transmit, to the another IAB node, a set of one or more parameters used for coordinating downlink resources and uplink resources in radio resources to be used for the IAB communication.

In another embodiment, the transmitting circuitry may be further configured to transmit, to the another IAB node, capability information used for indicating supported capabilities by the IAB node. Additionally, the supported capabilities may comprise at least one of: a capability of band combinations, a capability of number of carriers aggregated, a capability of Inter-RAT (Radio Access Technology), a capability of the number of transmit layers, a capability of the number of receive layers, and a capability of supported subcarrier spacings.

In another device embodiment, an Integrated Access and Backhaul (IAB) node may comprise: processing circuitry configured to have a capability to communicate IAB information with an another IAB node; and receiving circuitry configured to receive, from the another IAB node, a set of one or more parameters used for coordinating downlink resources and uplink resources in radio resources to be used for the IAB communication.

In another embodiment, the receiving circuitry may be further configured to receive, from the another IAB node, capability information used for indicating supported capabilities by the IAB node. Additionally, the supported capabilities may comprise at least one of: a capability of band combinations, a capability of number of carriers aggregated, a capability of Inter-RAT (Radio Access Technology), a capability of the number of transmit layers, a capability of the number of receive layers, and a capability of supported subcarrier spacings.

A method embodiment of an Integrated Access and Backhaul (IAB) node may comprise: having a capability to communicate IAB information with an another IAB node; and transmitting, to the another IAB node, a parameter(s) used for coordinating downlink resources and uplink resources in radio resources to be used for the IAB communication. The method may further comprise transmitting, to the another IAB node, capability information used for indicating supported capabilities by the IAB node.

In one embodiment, the supported capabilities may comprise at least one of: a capability of band combinations, a capability of number of carriers aggregated, a capability of Inter-RAT (Radio Access Technology), a capability of the number of transmit layers, a capability of the number of receive layers, and a capability of supported subcarrier spacings.

In another method embodiment of an Integrated Access and Backhaul (IAB) node capabilities and signaling, the method may comprise: communicating by the IAB node, IAB information with an another IAB node; and receiving, from the another IAB node, a set of one or more parameters used for coordinating downlink resources and uplink resources in radio resources to be used for the IAB communication.

The method may further comprise: receiving, by the another IAB node, capability information used for indicating supported capabilities by the IAB node. In one embodiment, the supported capabilities may comprise at least one of: a capability of band combinations, a capability of number of carriers aggregated, a capability of Inter-RAT (Radio Access Technology), a capability of the number of transmit layers, a capability of the number of receive layers, and a capability of supported subcarrier spacings.

### BRIEF DESCRIPTION OF THE DRAWINGS

The various embodiments of the present embodiments now will be discussed in detail with an emphasis on highlighting the advantageous features. These embodiments depict the novel and non-obvious aspects of the invention shown in the accompanying drawings, which are for illustrative purposes only. These drawings include the following figures, in which like numerals indicate like parts:

FIG. 1 illustrates a mobile network infrastructure using 5G signals and 5G base stations;

FIG. 2 illustrates a mobile network infrastructure where a number of UEs are connected to a set of IAB-nodes and the IAB-nodes are in communication with each other and/or an IAB-donor;

FIG. 3 illustrates an example flow of information transmit/receive and/or processing by a Parent gNB in communication with a Child gNB;

FIG. 4 illustrates an example flow of information transmit/receive and/or processing by a Parent gNB in communication with a Child gNB;

FIG. 5 is a functional block diagram of a wireless node device which may be a parent IAB-node that may be in communication with an IAB-donor upstream and a UE and/or child IAB-node downstream;

FIG. 6 is a functional block diagram of a wireless terminal device which may be an IAB-node in communication with an IAB-donor or a parent IAB-node upstream;

FIG. 7 illustrates an example of a radio protocol architecture for the discovery and control planes in a mobile network;

FIG. 8 illustrates an example of a set of components of a user equipment or base station;

FIG. 9 illustrates an example top level functional block diagram of a computing device embodiment; and

FIG. 10 illustrates an example flow chart diagram of a method for Capabilities and Signaling between Integrated Access and Backhaul Next Generation NodeBs.

### DETAILED DESCRIPTION

The various embodiments of the present Integrated Access and Backhaul Next generation NodeB Capabilities and Signaling now will be discussed in detail with an emphasis on highlighting the advantageous features. Additionally, the following detailed description describes the present embodiments with reference to the drawings.

A mobile network used in wireless networks, may be where the source and destination are interconnected by way of a plurality of nodes. In such a network the source and destination do not communicate with each other directly due to the distance between the source and destination being greater than the transmission range of the nodes. Accordingly, intermediate node(s) may be used to relay information signals. In a hierarchical telecommunications network, the backhaul portion of the network may comprise the intermediate links between the core network and the small subnetworks of the entire hierarchical network. Integrated Access and Backhaul (IAB) Next generation NodeB use 5G New Radio (NR) communications and typically provide more coverage per base station. That is, a 5G NR user equipment (UE) and 5G NR based station (gNB) may be used for transmitting and receiving NR User Plane data traffic and NR Control Plane data. Both, the UE and gNB may include addressable memory in electronic communication with a processor. In one embodiment, instructions may be stored in the memory and are executable to process received packets and/or transmit packets according to different protocols, for example, Medium Access Control (MAC) Protocol and/or Received Radio Link Control (RLC) Protocol.

The 3rd Generation Partnership Project, also referred to as “3GPP,” is a collaboration agreement that aims to define globally applicable technical specifications and technical reports for third, fourth, and fifth generation wireless communication systems. The 3GPP may define specifications for next generation mobile networks, systems, and devices. At least some aspects of the systems and methods disclosed herein may be described in relation to the 3GPP specifications, however, the scope of the present disclosure is not limited with this regard. Accordingly, at least some aspects of the systems and methods disclosed herein may be utilized in other types of wireless communication systems.

In 3GPP specifications, a base station is typically referred to as a Node B, an evolved or enhanced Node B (eNB), a next generation Node B (gNB), or some other similar terminology. As the scope of the disclosure should not be limited to 3GPP standards, the terms “base station” “Node B” “Node G” “eNB” and “gNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station.

The Integrated Access and Backhaul (IAB) Study Item envisions the sharing of time/frequency/space resources between UEs accessing a NR radio access network and base stations using resources for backhauling traffic. However, current agreements state that NR's Physical Layer (PHY) may be a “starting point” for NR design; hence colloquially a gNB (“child node”) that sends backhaul traffic to another gNB (“parent node”) may appear to the parent node as a “UE,” however, its capabilities will certainly be different than a standard UE.

In one embodiment, a Child gNB may appear as a UE to a Parent or Donor gNB in order to reduce specification complexity for the IAB. For example, the Child gNB appearing as a UE may transmit an indicator regarding whether the Child gNB can support concurrent transmission and reception on different bands for the band combination or an indicator regarding whether the Child gNB can support different uplink timing adjustments for the band combination. That is, the Parent gNB may initially view and process the Child gNB as if it were a UE, thereby reducing the need for having any additional complexity or processing.

In some aspects of the Integrated Access and Backhaul Next generation NodeB Capabilities and Signaling embodiments, the base stations may employ signaling and elements to allow for associated capabilities to be transmitted across base stations, where the associated capabilities are not taught by the UE capabilities being transmitted. Current systems provide a cellular broadcast channel that may be used as a basis for “downlink” (Parent to Child) of IAB information exchange associated with the Parent gNB, and UE Capability Information Signaling used as a basis for “uplink” (Child to Parent) IAB capability communication. In one embodiment, IAB nodes may need to exchange general information on the uplink, where the general information may be different than ones being exchanged by a typical UE. Embodiments of the present system disclose methods and devices for exchanging capability information from a Child gNB to a Parent gNB and a Parent gNB to a Child gNB. In particular, gNBs that are capable of multiple layer transmission as well as multiple layer reception.

In some examples of the Integrated Access and Backhaul Next generation NodeB Capabilities and Signaling embodiments, the following capabilities may need to be exchanged and/or communicated:
Release
Band combinations
   e.g., Supported band combinations defines the supported carrier aggregation combinations. For each band in a band combination, the supported bandwidth classes may be provided for DL and/or UL
Number of carriers aggregated
Inter-RAT capabilities (e.g., DC with legacy LTE)
Number of transmit layers
   e.g. PDSCH MIMO layers (the maximum number of MIMO layers)
   e.g. PUSCH MIMO layers (the maximum number of MIMO layers)
Number of receive layers
   e.g. PDSCH MIMO layers (the maximum number of MIMO layers)
   e.g. PUSCH MIMO layers (the maximum number of MIMO layers)
Supported subcarrier spacings
   e.g., supported subcarrier spacing for DL
   e.g., supported subcarrier spacing for UL
Supported maximum number of Bandwidth Parts (BWPs)
Supported maximum number of simultaneously Activated BWPs
Whether or not the gNB supports an “advanced” receiver that is either a Maximum Likelihood (ML) or approximate ML receiver. Alternatively, the “advanced” receiver support signaled could indicate a Maximum A Posteriori (MAP) receiver or approximate MAP receiver.
   Other capabilities, for example, the following capabilities may also be exchanged:
PDSCH and/or PUSCH DMRS type (type 1 or type 2)
PDSCH and/or PUSCH scheduling type (type A or type B)
Supported bandwidth
   Maximum DL bandwidth supported (e.g., per CC)
   Maximum UL bandwidth supported (e.g., per CC)
Bandwidth class (e.g., for DL and/or for UL)
   The bandwidth class is defined by the aggregated transmission bandwidth configuration and maximum number of component carriers supported

As more 5G/NR features are released more complexity is added to the infrastructure, and IAB node Capability Information has/will become lengthy and complicated Radio Messages. So as NR evolves and starts to include newer and more 5G/NR features, IAB Capability Information will require further consideration. Accordingly, in one embodiment, the system may compress Capability Information transfer by defining a “Capability ID,” for example, an index that may be implemented as pointing to a particular row in a table and/or database of potential capabilities, where an entry in the table might be 1 or 0 or some other signifier, depending on whether the capability is supported (e.g., indicating “1”) or not supported (e.g., indicating “0”). Accordingly, for the gNB nodes, the set of capability IDs (or indices)—which may be different from ones associated with UEs—may be implemented to indicate at least the aforementioned information during communications and/or exchanged on the uplink or downlink. An index mapping may provide for a reduced data transmission required to signal the capabilities of a gNB and thereby decrease the amount of traffic between IAB-nodes.

Embodiments relate to a link between gNB (Child) and gNB (Parent) and/or a link between gNB (Parent) and gNB (Child), or any other combination thereof, where backhaul resources may be shared. In some embodiments, the link between the gNBs is maintained and so the link may not go down for transmitting traffic (as opposed to a temporal link). Accordingly, to an IAB, two gNB may have a data link setup between them, where the link is setup and maintained as long as the network deems necessary to optimize throughput and capacity.

In some embodiments, a wireless communication system may comprise a first base station (e.g., a Child) and a second base station (e.g., a Parent) performing communication with each other via gNB for NR. In one embodiment, the Child base station may transmit a set of one or more information, e.g., Capability IDs, including Band combinations, Number of carriers aggregated, Inter-RAT capabilities (e.g., DC with legacy LTE), Number of transmit layers, Number of receive layers, or Supported subcarrier spacing. In one embodiment, the transmission of the set of information may be based on fluctuation of traffic and dynamically affect the resources needed to accommodate the efficient transmission. In an embodiment where coordination of resources is needed, the capability information related to the gNB may be transmitted based on a received query. That is, when connecting to a network, a UE or node may learn about the capabilities of the base station from the broadcast channel via, for example, system information blocks. Additionally, the present embodiments disclose methods for modifying or creating a new category of information on the uplink for defining the IAB gNB parameters to realize backhaul access. In some embodiments, the child of a Parent node may require its own capability and Capability IDs due to, for example, the specific capabilities of different base stations, Capability IDs for such base stations, e.g., gNB, and need for coordinated backhauling.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figurers, is not intended to limit scope—as claimed—but is merely representative of the systems and methods.

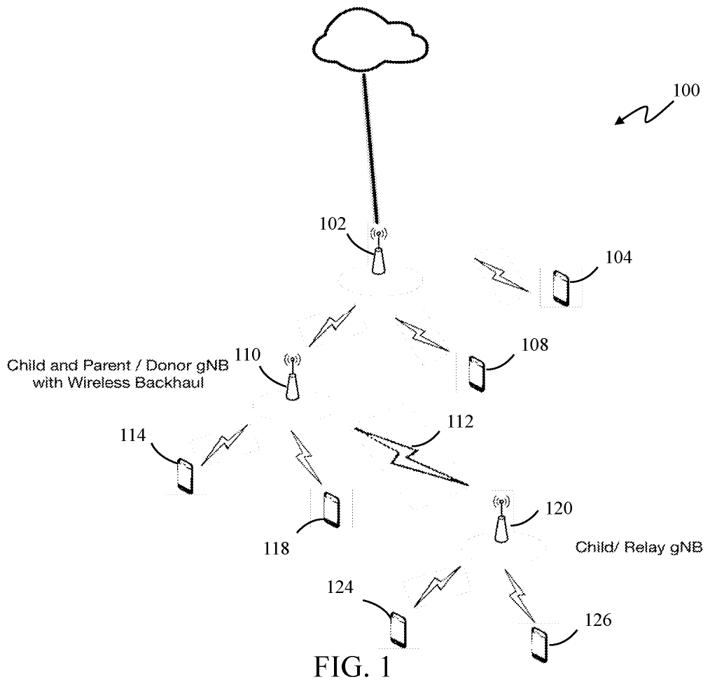

With reference to FIG. 1, the present embodiments include a mobile network infrastructure 100 using 5G signals and 5G base stations (or cell stations). As depicted, an integrated access provides gNBs with coordination between gNBs in response to changing cellular and backhaul traffic states, therefore changing parameters (e.g., Capability IDs) may be facilitated by transmission of such parameters. Allowing the coordination of resources in response thereof may be via the Integrated Access and Backhaul topology comprising the transmission of “downlink” (Parent to Child) IAB information exchange about the Parent gNB and “uplink” (Child to Parent) IAB information about the Child gNB, where the exchanged information may include Capability Information Signaling. Accordingly, modifying the coordination to allow the sharing of resources that are dependent on changing backhaul traffic conditions may be based on the transmission of such parameters that allow the coordination and control of radio resources.

With further reference to FIG. 1, a number of UEs (104, 108, 114, 118, 124, 126) are depicted as being in communication with gNBs (102, 110, 120), where further a Child gNB 110 is in communication with a Parent gNB 110 with wireless backhaul. Additionally, a Child gNB 120 is in communication with a Parent gNB 110 with wireless backhaul. For example, a Child gNB 120 may transmit 112 its capabilities to Parent gNB 110, thereby extending the Capability information to allow for the transmission of capabilities between parent and child for integrated access. The gNB 110 may be a Child and/or Parent with wireless backhaul capabilities where the gNB 110 is the Child gNB with respect to the connection to the Parent gNB 102 and the gNB 110 is a Parent gNB with respect to the connection to the Child gNB 120. The embodiments of the system provide for capabilities needed to be exchanged in order to control the NR features that exist in the NR mobile networks.

In some embodiments, management of signaling messages may include Capability Information Signaling via Radio Resource Controller (RRC) messaging between gNB that is transmitted on the uplink and/or downlink between the Parent gNB and Child gNB or Child gNB and Parent gNB. The Capability information may be needed to be transmitted during an initial registration process and/or based on whether there is a change in one or more capabilities of connected gNB.

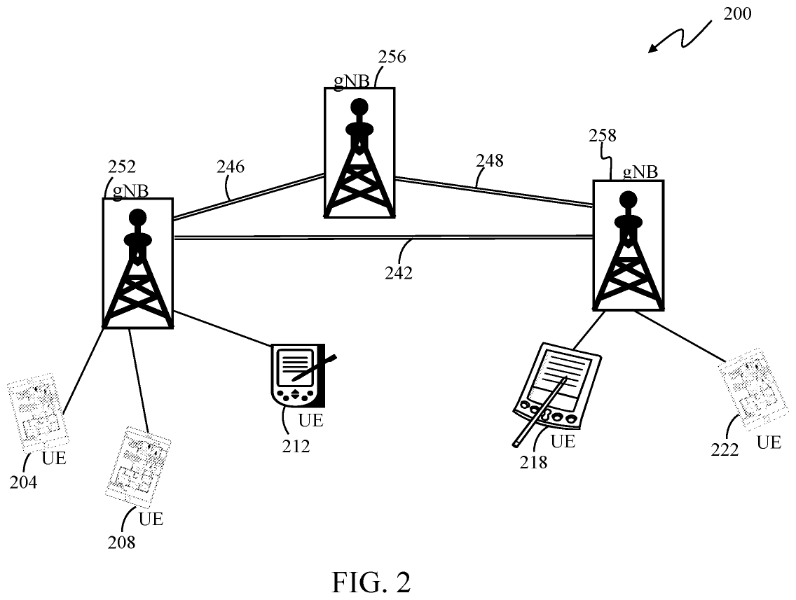

FIG. 2 depicts another example of a mobile network infrastructure 200 where a number of UEs (204, 208, 212, 218, 222) are connected to a set of gNBs (252, 256, 258) and the gNBs are in communication with each other using the different aspects of the present embodiments. That is, the gNBs may transmit 242, 246, 248 Capability IDs or information between each other where, in addition, a Parent gNB 256 may be capable of receiving multiple spatial layers of transmission (SU-MIMO). A Parent gNB may transmit capabilities needed to be exchanged to control the NR features, for examples, uploading Single User MIMO, from the Child node and then the Parent node.

In an embodiment where potential misalignment in time of the configured Distributed Unit (DU) and Mobile Terminated (MT) resources exists, an uplink timing adjustment may be performed and the gNB may need more than one transmitter. Further, DU resource configuration may include new slot formats defined only for IAB nodes (DU and MTs) which begin with uplink slots, uplink symbols, or flexible symbols. In one embodiment, the resources may be configured on a per DU (cell) basis.

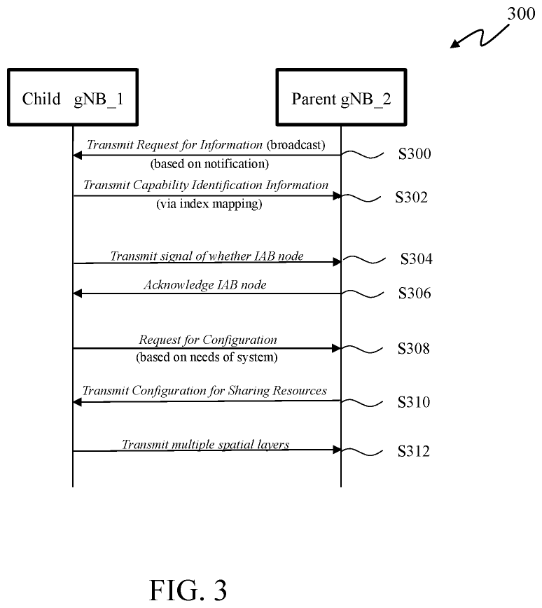

FIG. 3 is a diagram of an example flow of information 300 send/receive and/or processed by a Child base station (gNB_1) and Parent base station (gNB_2), according to an embodiment of the invention for capability signaling. The communication method of FIG. 3 depicts an Integrated Access and Backhaul capabilities signaling by a Child base station where the Parent base station may transmit a request for information (S300) based on a notification from the system that a new base station is connected and available for communication or that there is a change in the backhaul traffic conditions and a notification in wireless communication system indicating that a new base station is available for communication. The Child base station may then respond by transmitting capability identification (capability ID) associated with the first base station (S302), where the capability identification may be transmitted via an index mapping to a plurality of capability identification. The Child base station may additionally transmit a signal to the Parent base station to indicate whether the Child base station is an IAB node (S304). In this embodiment, the Parent base station may acknowledge (S306) the Child base station's signal and treat it as an IAB node. If the Child base station is an Integrated Access and Backhaul node, and for example, receives the acknowledgement, the Child base station may transmit a request for configuration information (S308) from the Parent base station. The Parent base station may transmit configuration information (S310) for sharing resources based on needs of the wireless communication system and supported capabilities. In some embodiment, the Child base station may not wait for an acknowledgement from the Parent base station accepting the Child base station as an IAB node and instead, may request configuration information to provide resources to the system, for example, for backhaul traffic. In another embodiment, the Parent base station may receive multiple spatial layers of transmission (S312) from the first base station and/or other base stations, for example, where the other base stations have been acknowledged to be IAB nodes.

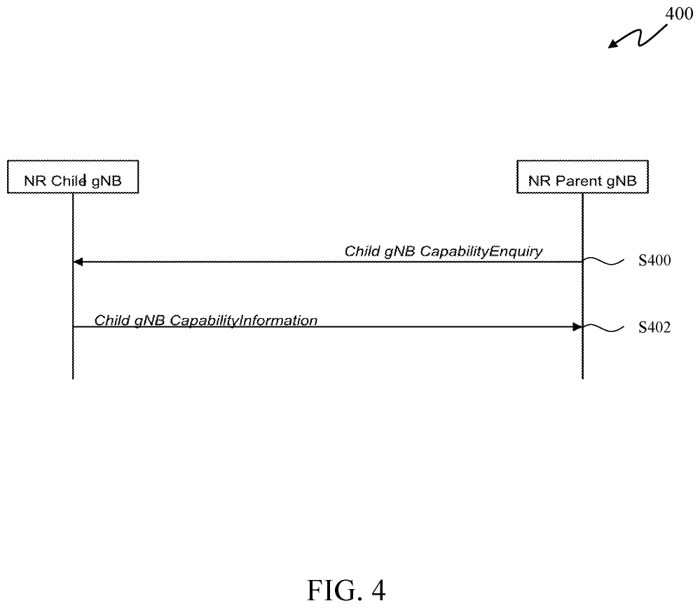

FIG. 4 depicts an initial communication signaling 400 in an NR mobile network between a Child gNB and a Parent gNB. In this embodiment, the Parent gNB initiates by transmitting a Child gNB Capability Enquiry (S400) when, for example, the Child is available for communication or a change in the backhaul traffic conditions has been detected. The Child gNB may then respond by sending the Capability Information (S402) associated with it to the Parent gNB for further processing and ability to provide shared resources to the system.

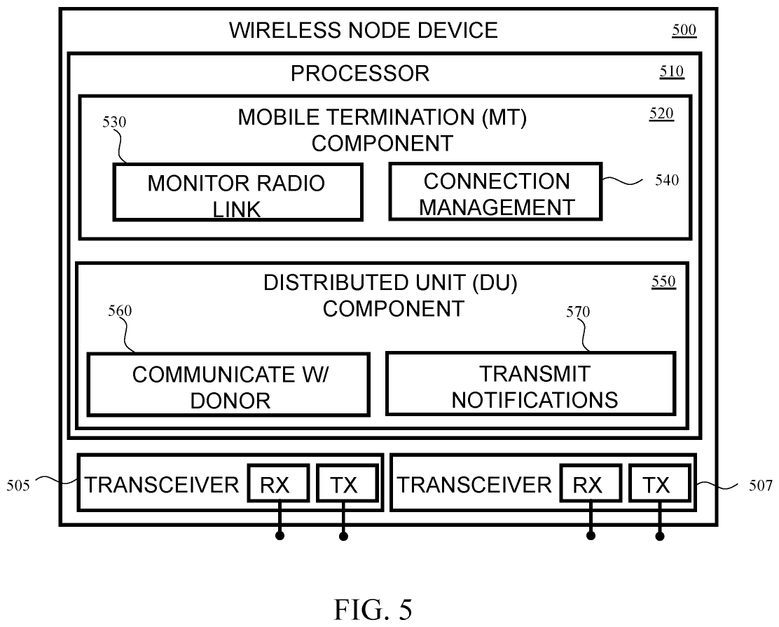

FIG. 5 is a functional block diagram of a wireless node device 500 which may be a parent IAB-node that may be in communication with an IAB-donor upstream and a UE and/or child IAB-node downstream. In some embodiments, the parent IAB-node may itself be connected to another IAB-node upstream and accordingly, part of an end to end connection between a set of IAB-nodes and an IAB-donor (see also FIGS. 1 and 2). The set of IAB-nodes may include a processor 510 and two transceivers (505, 507), where each transceiver may have a transmitter component and a receiver component, and in some embodiments, one transceiver may be used for connection to and communications with upstream devices (upstream radio links) and the other used for connection to and communications with downstream devices (downstream radio links). That is, in one embodiment, one transceiver 505 may be dedicated to communicating with IAB-donors/parent IAB-nodes (e.g., via a Mobile Termination (MT) component) and the other transceiver 507 with child IAB-nodes and/or UEs (e.g., via a Distributed Unit (DU) component). The mobile-termination component 520 may provide a function that terminates the radio interface layers, similar to a UE but implemented on the IAB-nodes as disclosed herein. The example wireless node device 500 depicted in FIG. 5 may further include a processor 510 which may comprise the Mobile-Termination (MT) component 520 and the Distributed Unit (DU) component 550. In this embodiment, the MT component 520 may be configured to monitor the radio link 530 on the upstream radio links. The MT component 520 may also include a connection management 540 that may provide, for example, cell selection, connection establishment and reestablishment functionality. The DU component 550 may be configured to communicate with the IAB-donor, for example, for relay configuration. The DU component 550 may also be configured to process the detected radio link conditions and transmit notifications 570 representing the radio link conditions to the downstream nodes.

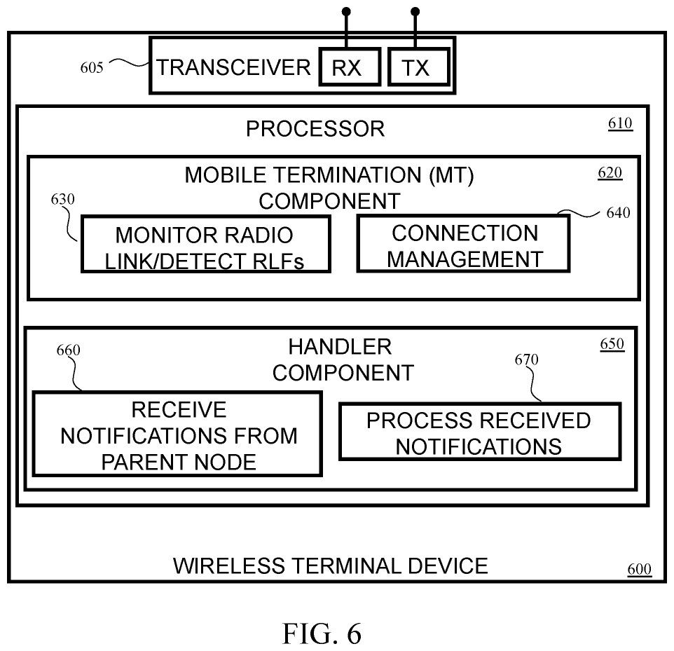

FIG. 6 is a functional block diagram of a wireless terminal device 600 which may be a UE and/or child IAB-node in communication with an IAB-donor or a parent IAB-node upstream (itself in communication with an IAB-donor). The wireless terminal device may include a transceiver 605 having a transmitter and receiver for communicating with other IAB-donors/nodes upstream. The example wireless terminal device depicted may further include a processor 610 which may comprise the Mobile-Termination (MT) component 620 and handler component 650. In this embodiment, the MT component 620 may be configured to monitor the radio link 630. The MT component 620 may also include a connection management 640 that may provide, for example, cell selection, connection establishment and reestablishment functionality. The handler component 650 may be configured to receive notifications 660 from a parent node, for example, an IAB-donor or parent IAB-node upstream, the notifications representing radio conditions of the parent node's upstream radio links. The handler component 650 may also be configured to process the received notifications 670 from upstream nodes according to the aspects of the different embodiments.

The different aspects of the present embodiments provide transmitting circuitry configured to transmit, to the another IAB node, a set of one or more parameters used for coordinating downlink resources and uplink resources in radio resources to be used for the IAB communication. For example, the transceiver 505 may be used to transmit the set of one or more parameters related to the capability information used for indicating supported capabilities by the IAB node (e.g., the wireless node device 500) to another IAB node. The same IAB node (e.g., the wireless node device 500) may also provide receiving circuitry, via the transceiver 507, configured to receive, from the another IAB node, a similar set of one or more parameters used for coordinating downlink resources and uplink resources in radio resources to be used for the IAB communication.

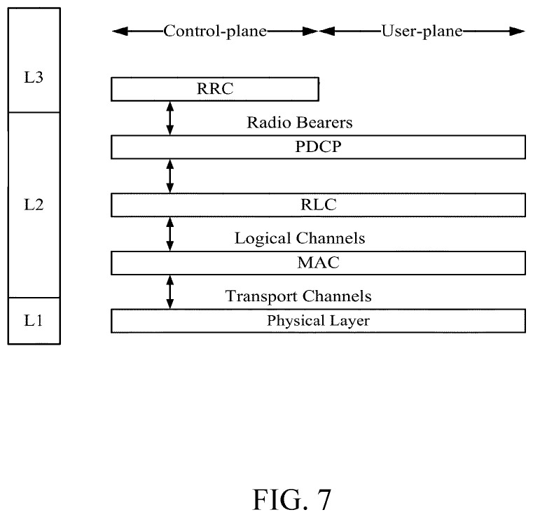

FIG. 7 is a diagram illustrating an example of a radio protocol architecture for the discovery and control planes in a mobile communications network. The radio protocol architecture for the gNB and/or the UE may be shown with three layers: Layer 1, Layer 2, and Layer 3. Layer 1 (L1 layer) is the lowest layer and implements various physical layer signal processing functions. Layer 2 (L2 layer) is above the physical layer and responsible for the link between the UE and gNB over the physical layer. In the user plane, the L2 layer includes a media access control (MAC) sublayer, a radio link control (RLC) sublayer, and a packet data convergence protocol (PDCP) sublayer, which are terminated at the gNB on the network side. Although not shown, there may be several upper layers above the L2 layer including a network layer (e.g., IP layer) that is terminated at the PDN gateway on the network side, and an application layer that is terminated at the other end of the connection (e.g., far end UE, server, etc.). The control plane also includes a radio resource control (RRC) sublayer in Layer 3 (L3 layer). The RRC sublayer is responsible for obtaining radio resources (i.e., radio bearers) and for configuring the lower layers using RRC signaling between the gNB and another gNB or the UE.

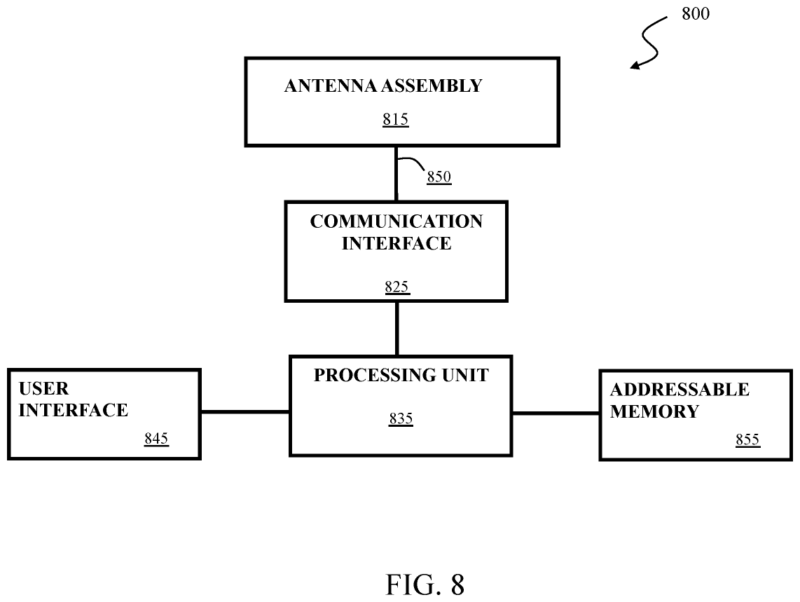

FIG. 8 illustrates an embodiment of a user equipment and/or base station comprising components of a device 800 according to the present embodiments. The device 800 illustrated may comprise an antenna assembly 815, a communication interface 825, a processing unit 835, a user interface 845, and an addressable memory 855. Where the antenna assembly 815 may be in direct physical communication 850 with the communication interface 825. The addressable memory 855 may include a random access memory (RAM) or another type of dynamic storage device, a read only memory (ROM) or another type of static storage device, a removable memory card, and/or another type of memory to store data and instructions that may be used by the processing unit 835.

The communication interface 825 may include a transceiver that enables IAB nodes and/or mobile communication devices to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. The communication interface 825 may include a transmitter that converts baseband signals to radio frequency (RF) signals and/or a receiver that converts RF signals to baseband signals. The communication interface 825 may also be coupled (not shown) to antenna assembly 815 for transmitting and receiving RF signals. Additionally, the antenna assembly 815 may include one or more antennas to transmit and/or receive RF signals. The antenna assembly 815 may, for example, receive RF signals from the communication interface and transmit the signals and provide them to the communication interface.

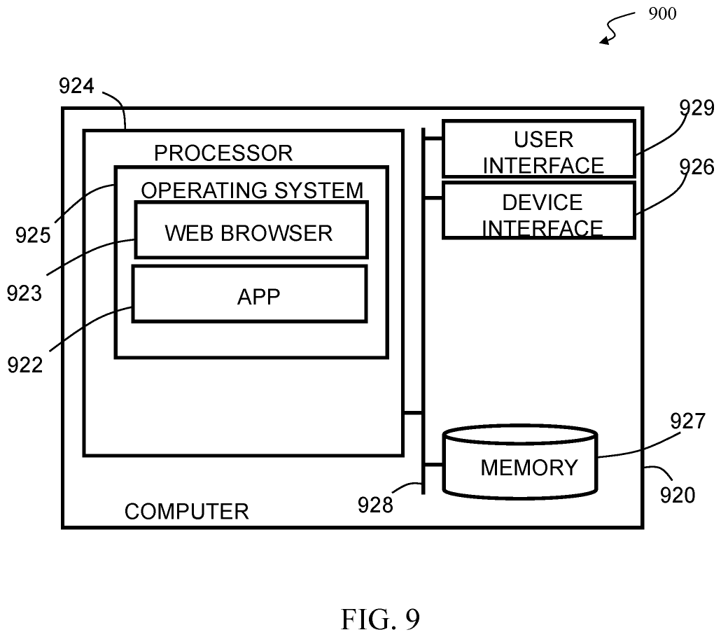

FIG. 9 illustrates an example of a top level functional block diagram of a computing device embodiment 900. The example operating environment is shown as a computing device 920 comprising a processor 924, such as a central processing unit (CPU), addressable memory 927, an external device interface 926, e.g., an optional universal serial bus port and related processing, and/or an Ethernet port and related processing, and an optional user interface 929, e.g., an array of status lights and one or more toggle switches, and/or a display, and/or a keyboard and/or a pointer-mouse system and/or a touch screen. Optionally, the addressable memory may, for example, be: flash memory, eprom, and/or a disk drive or other hard drive. These elements may be in communication with one another via a data bus 928. Via an operating system 925 such as one supporting a web browser 923 and applications 922, the processor 924 may be configured to execute steps of a process establishing a communication channel according to the exemplary embodiments described above.

As discussed, for simplicity of description, the term “IAB-donor” is used to represent either a “parent IAB-node” regarding an IAB-node, or a practical “IAB-donor” which is responsible for the physical connection with the core network.

In one embodiment, an IAB-node may follow the same initial access procedure as a UE, including cell search, system information acquisition, and random access, in order to initially set up a connection to a parent IAB-node or an IAB-donor. That is, when an IAB base station (eNB/gNB) needs to establish a backhaul connection to, or camp on, a parent IAB-node or an IAB-donor, the IAB-node may perform the same procedures, and steps as a UE, and the IAB-node may be treated as a UE, by the parent IAB-node or the IAB-donor.

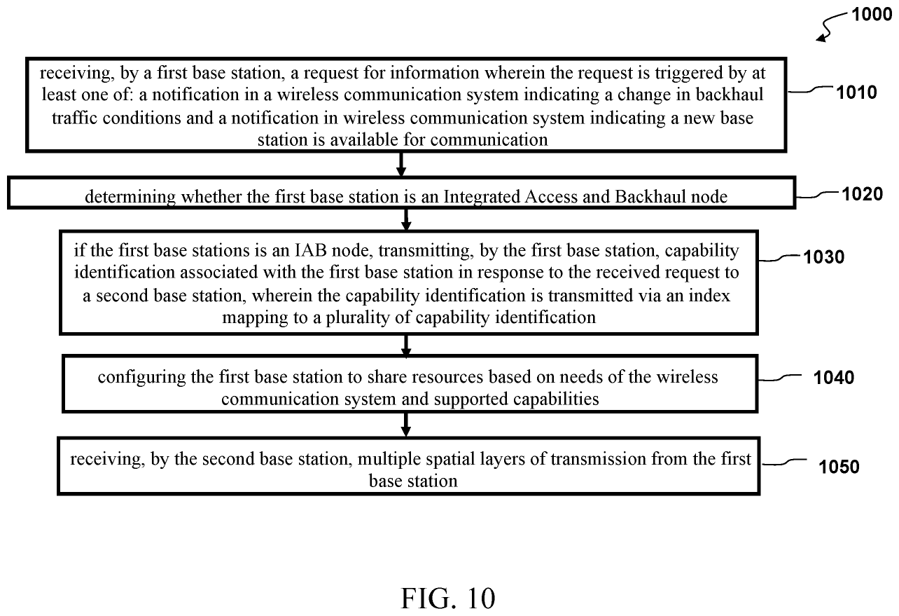

FIG. 10 is a flow chart showing an example method embodiment of IAB gNB capabilities and signaling by a base station. The method including, in no particular order, the steps of (a) receiving, by a first base station, a request for information wherein the request is triggered by at least one of: a notification in a wireless communication system indicating a change in backhaul traffic conditions and a notification in wireless communication system indicating a new base station is available for communication (step 1010); (b) determining whether the first base station is an Integrated Access and Backhaul node (step 1020); (c) if the first base stations is an IAB node, transmitting, by the first base station, capability identification associated with the first base station in response to the received request to a second base station, wherein the capability identification is transmitted via an index mapping to a plurality of capability identification (step 1030); (d) configuring the first base station to share resources based on needs of the wireless communication system and supported capabilities (step 1040); and (e) receiving, by the second base station, multiple spatial layers of transmission from the first base station (step 1050). In one embodiment the first base station may be a gNB, the second base station may be a gNB, and/or both base stations may be gNBs. In another embodiment, the capability information may be at least one of: Band combinations, Number of carriers aggregated, Inter-RAT capabilities, Number of transmit layers, Number of receive layers, and Supported subcarrier spacings.

In one embodiment, a Physical Downlink Shared Channel (PDSCH) is the physical channel that carries the data for mapping type A, where the duration is between the first OFDM symbol of the slot and the last OFDM symbol of the scheduled PDSCH resources in the slot. For PDSCH mapping type B, the duration may be the number of OFDM symbols of the scheduled PDSCH resources as signalled.

The abovementioned features may be applicable to 3rd Generation Partnership Project (3GPP); Technical Specification Group Radio Access Network; Study on Integrated Access and Backhaul; (Release 15) for 3GPP TR 38.874 V0.3.2 (2018-06), 3GPP TR 38.874 V16.0.0 (2018-12), and any other applicable standards.

The above description presents the best mode contemplated for carrying out the present embodiments, and of the manner and process of practicing them, in such full, clear, concise, and exact terms as to enable any person skilled in the art to which they pertain to practice these embodiments. The present embodiments are, however, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed concurrently. Likewise, steps that have been presented as being performed concurrently may in alternative embodiments be performed separately.

What is claimed is:

1. An Integrated Access and Backhaul (IAB) node comprising:
processing circuitry configured to have a capability to communicate IAB information with an another IAB node; and
transmitting circuitry configured to transmit, to the another IAB node, a set of one or more parameters used for coordinating downlink resources and uplink resources in radio resources to be used for the IAB communication.

2. The IAB node according to claim 1, wherein
the transmitting circuitry is further configured to transmit, to the another IAB node, capability information used for indicating supported capabilities by the IAB node.

3. The IAB node according to claim 2, wherein
the supported capabilities comprise at least one of: a capability of band combinations, a capability of number of carriers aggregated, a capability of Inter-RAT (Radio Access Technology), a capability of the number of transmit layers, a capability of the number of receive layers, and a capability of supported subcarrier spacings.

4. An Integrated Access and Backhaul (IAB) node comprising:
processing circuitry configured to have a capability to communicate IAB information with an another IAB node; and
receiving circuitry configured to receive, from the another IAB node, a set of one or more parameters used for coordinating downlink resources and uplink resources in radio resources to be used for the IAB communication.

5. The IAB node according to claim 4, wherein
the receiving circuitry is further configured to receive, from the another IAB node, capability information used for indicating supported capabilities by the IAB node.

6. The IAB node according to claim 5, wherein
the supported capabilities comprise at least one of: a capability of band combinations, a capability of number of carriers aggregated, a capability of Inter-RAT (Radio Access Technology), a capability of the number of transmit layers, a capability of the number of receive layers, and a capability of supported subcarrier spacings.

7. A method of an Integrated Access and Backhaul (IAB) node comprising:
having a capability to communicate IAB information with an another IAB node; and
transmitting, to the another IAB node, a parameter(s) used for coordinating downlink resources and uplink resources in radio resources to be used for the IAB communication.

8. The method according to claim 7, further comprising:
transmitting, to the another IAB node, capability information used for indicating supported capabilities by the IAB node.

9. The method according to claim 8, wherein
the supported capabilities comprise at least one of: a capability of band combinations, a capability of number of carriers aggregated, a capability of Inter-RAT (Radio Access Technology), a capability of the number of transmit layers, a capability of the number of receive layers, and a capability of supported subcarrier spacings.

10. A method of an Integrated Access and Backhaul (IAB) node capabilities and signaling, the method comprising:
communicating by the IAB node, IAB information with an another IAB node; and
receiving, from the another IAB node, a set of one or more parameters used for coordinating downlink resources and uplink resources in radio resources to be used for the IAB communication.

11. The method according to claim 10, further comprising:
receiving, by the another IAB node, capability information used for indicating supported capabilities by the IAB node.

12. The method according to claim 11, wherein
the supported capabilities comprise at least one of: a capability of band combinations, a capability of number of carriers aggregated, a capability of Inter-RAT (Radio Access Technology), a capability of the number of transmit layers, a capability of the number of receive layers, and a capability of supported subcarrier spacings.
